(19) United States
(12) Patent Application Publication
(10) Pub. No.: US 2026/0178591 A1
(43) Pub. Date: Jun. 25, 2026

(54) METHOD FOR ENHANCING SEARCHING BASED ON CONTEXT AWARENESS

(71) Applicant: LENOVO (SINGAPORE) PTE. LTD., SINGAPORE (SG)

(72) Inventors: Matthew Fardig, Boonville, IN (US); Dane Hixson, Eden, UT (US); Lindsay Nelson, Highlands Ranch, CO (US); Joshua Smith, Milton, FL (US)

(21) Appl. No.: 19/541,762

(22) Filed: Feb. 17, 2026

Related U.S. Application Data
(63) Continuation of application No. 17/815,911, filed on Jul. 28, 2022, now abandoned.

(51) Int. Cl. G06F 16/2457

(52) U.S. Cl. CPC G06F 16/24575

(57) ABSTRACT

A method is provided where under control of one or more processors configured with executable instructions, the method include receiving a user instruction from a user to perform a search on an electronic device, and identifying a subject matter topic based on the user instruction. The method also includes identifying real time context awareness information related to the user interaction with a resource identified by the electronic device in response to the user instruction, and obtaining additional resources related to the search based on the real time context awareness information related to the user interaction with the resource.

### CROSS-REFERENCE TO RELATED APPLICATIONS

This application is a continuation of U.S. patent application Ser. No. 17/815,911, filed 28 Jul. 2022, the entire disclosure of which is incorporated herein by reference.

### FIELD

The present disclosure relates generally to enhancing the searching of information on the Internet of Things (IoT) based on context awareness.

### BACKGROUND OF THE INVENTION

The IoT is full of resources that can be used when researching topics, information, etc. including utilizing IoT search engines. However, when IoT based search engines are utilized, often irrelevant, and unhelpful information is obtained. For example, when teachers ask students to use the IoT to perform research, they end up in situations where the students are all over the place. Some manage to find useful resources, or websites, while some end up in places that have no value to the assignment, etc. In particular, students can enter keywords, and the search engines return matches. Still, because search engines offer a lot of flexibility in terms of keyword searching, date/time filters, exclusions, etc., the results of the search do not consider the context of the research that the student is doing.

As an example, if a student in a 3rd grade class is researching a topic, and a student in a college classroom is researching a similar topic, each student does not get the benefit from the same websites. The 3rd grade class might benefit from resources that utilize more pictures, smaller words, etc. while a college classroom might focus on more advanced analysis of the topic, things that could be potentially offensive or difficult to understand for a younger audience, etc. Teachers can also spend time ahead of class doing their own searching to find websites that might be useful for their lesson plan. They can collaborate with peers to see what their peers have found useful, etc. Then during the class, the teacher has to manually pay attention to what students are struggling in their online research and reach out manually to them to offer help.

Accordingly, a need remains for methods and devices to facilitate IoT searching.

### SUMMARY

In accordance with embodiments herein, a method is provided where under control of one or more processors configured with executable instructions, the method include receiving a user instruction from a user to perform a search on an electronic device, and identifying a subject matter topic based on the user instruction. The method also includes identifying real time context awareness information related to the user interaction with a resource identified by the electronic device in response to the user instruction, and obtaining additional resources related to the search based on the real time context awareness information related to the user interaction with the resource.

Optionally, the method also includes determining the resource is relevant to the search based on the user interaction with the resource, analyzing the resource identified by the electronic device in response to determining the resource is relevant to the search, and identifying the additional resources based analyzing the resource. In one aspect, to analyze the resource includes utilizing a natural language processing of the resource. In another aspect the method includes analyzing the real time context awareness information to determine the additional resources. Optionally, the one or more processors utilize an artificial intelligence algorithm or machine learning algorithm to analyze the real time context awareness information in real time to determine the additional resources. In one example the method also includes storing the resource identified by the electronic device based on the real time context awareness information related to the user interaction with the resource.

Optionally, obtaining additional resources related to the search based on the real time context awareness information related to the user interaction with the resource includes associating the resource and additional resources with the subject matter topic identified. In one aspect, a sensor of the electronic device captures user characteristic information related to the user to identify in real time the real time context awareness information. In another aspect, the resource is selected from the group consisting of webpage, website, file, and document. In one example, obtaining the additional resources includes recommending the additional resources to the user. In another example, the method also includes indicating the resource is not relevant to the search based on the real time context awareness information. In yet another example, the method also includes prioritizing the additional resources in real time based on the real time context awareness information.

In accordance with embodiments herein, an electronic device is provided that includes an input device to receive a user instruction of a user to perform a search, a processor, and a memory storing program instructions accessible by the processor. Responsive to execution of the program instructions, the processor performs identifying real time context awareness information related to the user interaction with a resource identified by the electronic device in response to the user instruction, and obtaining additional resources related to the search based on the real time context awareness information related to the user interaction with the resource.

Optionally, the processor further performs determining the resource is relevant to the search based on the user interaction with the resource, analyzing the resource identified by the electronic device in response to determining the resource is relevant to the search, and identifying the additional resources based analyzing the resource. In one aspect, to analyze the resource includes utilizing a natural language processing of the resource. In another aspect, the processor further performs analyzing the real time context awareness information to determine the additional resources. In one example, the processor utilizes an artificial intelligence algorithm or machine learning algorithm to analyze the real time context awareness information in real time to determine the additional resources. In another example, the electronic device also includes a camera for obtaining real time context awareness information.

In accordance with embodiments herein, a computer program product is provided that includes a non-signal computer readable storage medium comprising computer executable code to receive a user instruction from a user to perform a search on an electronic device, and identify a subject matter topic based on the user instruction. The computer executable code also to identify real time context awareness information related to the user interaction with a resource identified by the electronic device in response to the user instruction, and obtain additional resources related to the search based on the real time context awareness information related to the user interaction with the resource. Optionally, the computer executable code also to determine the resource is relevant to the search based on the user interaction with the resource, analyze the resource identified by the electronic device in response to determining the resource is relevant to the search, and identify the additional resources based analyzing the resource.

### BRIEF DESCRIPTION OF THE DRAWINGS

FIG. 1 illustrates a system for searching the IoT based on context awareness information in accordance with embodiments herein.

FIG. 2 illustrates a schematic view of an environment in which embodiments herein may be implemented.

FIG. 3 illustrates a block flow logic diagram of an electronic device utilized to enhance searching, in accordance with embodiments herein.

FIG. 4 illustrates a process for enhancing searching on an electronic device, in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

### Terms

The term “context awareness information” refers to information indicative of a condition present in an environment in which one or more electronic devices are located. Nonlimiting examples of context awareness information include an identity of a user of an electronic device within an environment, the setting or details related to the environment, terms utilized in a search inquiry, or the like.

The term “environment” refers to a physical region in which one or more electronic devices are located and in which actions performed by the electronic device are perceived (e.g., heard, seen, felt) by individuals. By way of example, an environment may refer to one or more rooms in a home, school, library, office, or other structure. An environment may or may not have physical boundaries. For example, an environment instead be defined based upon a range over which individuals may perceive actions by electronic devices. For example, an environment may refer to one or more of a pool area, a deck on a house, a backyard, an exterior area outside of an office building, a commercial area, school, and the like, where approximate virtual boundaries of the environment correspond to the range over which actions by electronic devices may be heard, seen, felt or otherwise perceived. When an electronic device is portable and/or handheld, an environment associated with the electronic device may shift over time when the electronic device is moved. For example, an environment surrounding a smart phone, tablet device or laptop computer moves with the smartphone, tablet device or laptop computer. An environment surrounding an electronic device will shift each time the electronic device is relocated, such as when moved between different rooms of a home, office building or other residential or commercial structure.

The term “user instruction” as used herein refers to any and all actions, questions, inquiries, or the like that result in searching for information using an electronic device. The user instructions can include words typed into a text box, auditory instructions provided to a microphone, the actuation of a search function, etc. To this end, the instruction does not have to be a question, inquiry, or the like. Instead, by causing a search to occur a user instruction has been provided. As an example, if the phrase “War of 1812” is inputted into a search engine, and the search engine is actuated, a user instruction to search for information related to the War of 1812 is provided.

The term “subject matter topic” as used herein refers to any and all people, places, events, ideas, periods, etc. that can be researched. The subject matter topic can be a person such as John F. Kennedy, a group of people such as U.S. Presidents, events such as the Civil War, periods such as the Renaissance Period, ideas such as the theory of relativity, or the like. The subject matter topic is what a user is researching.

The term “resource” as used herein refers to any webpage, website, file, document, presentation, or the like that contain information that can be searched. In one example a resource can be a network resource such as a webpage or website that is found on the IoT, or utilizing a network. In another example, the resource can be a local resource such as a file, document, etc. stored in a local storage device that is not in a network.

The term “real time” as used herein shall mean at the same time, or a time substantially contemporaneous, with an occurrence of another event or action. For the avoidance of doubt, as an example, when a search is requested by a user and relevant resources are provided in real-time in response to the search, the relevant resources are received by the user within a few seconds of the search.

The term “obtain” or “obtaining”, as used herein in connection with data, information and the like, includes at least one of i) accessing memory of a local external device or resource manager where the data, signals, information, etc. are stored, ii) receiving the data, signals, information, etc. over a wireless communications link between the client device and a local external device, and/or iii) receiving the data, signals, information, etc. at a resource manager over a network connection. The obtaining operation, when from the perspective of a client device, may include sensing new signals in real time, and/or accessing memory to read stored data, signals, information, etc. from memory within the client device. The obtaining operation, when from the perspective of a local external device, includes receiving the data, signals, information, etc. at a transceiver of the local external device where the data, signals, information, etc. are transmitted from a client device and/or a resource manager. The obtaining operation may be from the perspective of a resource manager, such as when receiving the data, signals, information, etc. at a network interface from a local external device and/or directly from a client device. The resource manager may also obtain the data, signals, information, etc. from local memory and/or from other memory, such as within a cloud storage environment and/or from the memory of a workstation.

### OVERVIEW

A method is provided for utilizing user context awareness information within an environment to automatically curate a collection of meaningful resources for searching a subject matter topic. The subject matter topic can be identified, including by utilizing a pre-defined agenda is fed into the system, utilizing an automatic subject matter topic analysis based on whatever is displayed on a screen of the user or in the environment, manual entry of the subject matter topic, voice analysis from a microphone, or the like. A research application then monitors context awareness information such as the web history for a user and determines the relevancy of resources. In one example the relevancy of the resources can be determined utilizing an artificial intelligence or machine learning algorithm the obtains information related to the interaction of the user to different resources. For example, the research application can monitor how long a user stays on, or reviews, a resource, where the assumption can be made that if a user reviews a website for a longer period of time, that the resource is relevant. Likewise, if a user accesses a resource, then quickly accesses another website, an indication is provided that the resource is not relevant. The research application can also monitor how students interact with a resource. For example, if a user starts at the top of the resource and slowly scrolls to the bottom, an indication is provided the resource is relevant. In another example the research application can monitor workgroups that may be researching the same subject matter topic for patterns that indicate a resource is proving to be relevant. For example, four students are working together. Student A goes to a website, and then soon after, Students, B, C and D all navigate to that same website. This indicates that the website (e.g. resource) is relevant. The research application can also provide a sentiment analysis of chat messages or vocal communication within a group that can be analyzed at the time that a resource is loaded in a user browser. This can help determine if the user in a workgroup are having a positive or negative experience with a website. The research application can also monitor emotion analysis (e.g. image data including from a camera) to determine if users in a workgroup are having a positive or negative experience with a given website. In yet another example, the research application can utilize natural language processing (NPL) to analyze the content of the page to determine the validity of the content of the page compared to the subject matter topic. Likewise, analysis of the reading level of the page could be used to determine if it could be understood by the target audience. The research application then can store a list of the resources that are relevant for different subject matter topics, as well as a list of resources that are not relevant for later use.

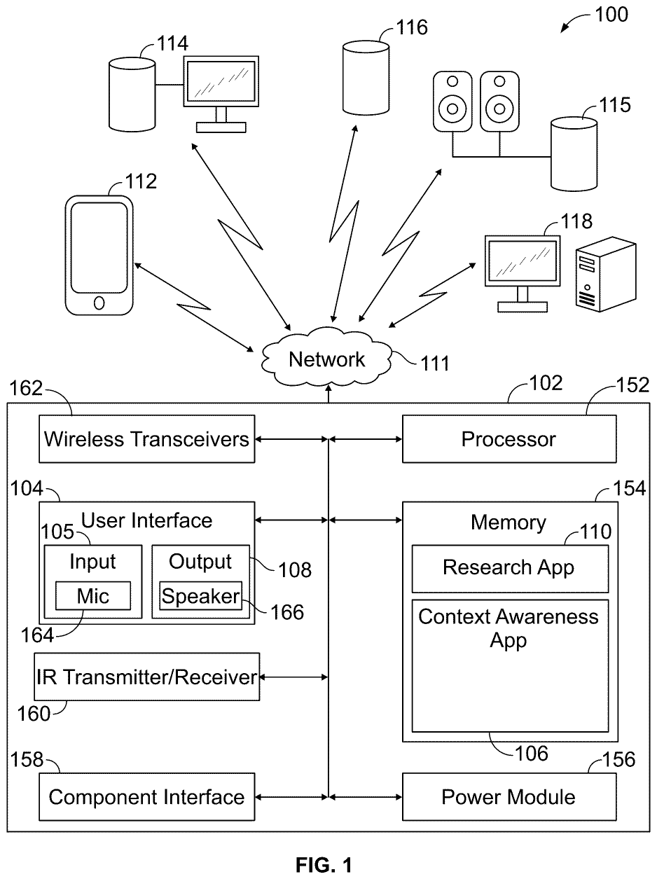

FIG. 1 illustrates a system 100 for enhancing information gathering including related to a search engine based on real time context awareness of an electronic device 102 in accordance with embodiments herein. The system 100 includes the electronic device 102 that is configured to obtain real time context awareness information related to both the user and the environment of the user, and then facilitate gathering of the information, including via a search engine, based on the user and the subject matter topic being searched. The electronic device 102 in example embodiments can be a laptop computer, central processing unit (CPU), desktop computer, smartphone, smartwatch, Tablet, smart TV, or the like.

As shown in FIG. 1, the electronic device 102 includes components such as one or more processors 152 (e.g., a microprocessor, microcomputer, application-specific integrated circuit, etc.), one or more local storage medium (also referred to as a memory) 154, a user interface 104 which includes one or more input circuits 105 and one or more output circuits 108, a power module 156, a component interface 158, an infrared transmitter receiver 160 and one or more wireless transceivers 162. All of these components can be operatively coupled to one another, and can be in communication with one another, by way of one or more internal communication links, such as an internal bus.

The local storage medium 154 can store information related to searches or inquires a user may have. For example, in a classroom environment when the user is a student, the student may be researching an assignment about a historical figure. The local storage medium may include additional resources such as files, webpages, website names or links, search terms, or the like from previous students who researched the same historical figure. To this end, any new search that is determined to be helpful or contain relevant information can similarly be stored within the memory 154 for future students that may research the same historical figure.

The input circuit 105 in one example supports a microphone 164. Alternatively the input circuit 105 can support a keyboard, touch screen, touch pad, mouse, or the like. The input circuit 105 cooperates with the input device 105 (e.g. microphone 164), and receives user instructions in various manners. For example, the input device can communicate with a context awareness application 106 that can determine the user of the electronic device 102, user characteristics, environmental characteristics, or the like. User characteristics can include the user age, gender, accent, or the like. The processors 152 also execute program instructions stored in the memory 154 to interpret and perform actions based on user instructions that are received through the input circuit 105. The user instructions may represent requests of various types. By way of example, some types of user instructions seek information, such as a question that may be answered by the electronic device 102 based on content stored therein and/or an automated searched over the IoT and the like.

In one example, the context awareness application 106 receives inputs from a keyboard and/or mouse, mouse pad, or the like in real time. As an example, the keyboard may be utilized to type inquires into a search engine. Alternatively, a keyboard functions, such as a copy and paste function may be utilized to copy terms, titles, etc. from a resource or additional resource such as a document, webpage, or the like on an output screen and place it into a search engine. Alternatively, the context awareness application 106 can receive inputs from a microphone. The microphone can receive voice based user instructions, voice data, or the like. In yet another example, the context awareness application 106 can receive inputs that are communicated from another electronic device 112-116, via the cloud, through a network, etc. The other electronic devices 112-116 may include one or more sensors, keyboards, mouses, microphones, or the like that can obtain real time context awareness information about the user, environment of the user, or the like, and communicate the real time context awareness information to the electronic device 102.

The electronic device 102 also includes an output circuit 108 and the transceivers 162, one or both of which may output incoming and/or modified user instructions to the collection of responsive electronic devices. The output circuit in one example supports a speaker 166. In other examples, the output circuit can support a display, screen, touchscreen, or the like. The transceiver 162 in one example also receives real time context awareness information from other electronic devices 112-116. The electronic device 102 includes the user interface 104 and is configured to access a network 111 over a wired or wireless connection. As non-limiting examples, the electronic device 102 may access the network 111 through a wireless communications channel and/or through a network connection (e.g., the IoT). Additionally or alternatively, the electronic device 102 may be a wired or wireless communication terminal, such as a desktop computer, laptop computer, network-ready television, set-top box, and the like.

The one or more of the electronic devices 112-116 may represent the same type or different types of electronic device as the electronic device 102, and/or a speaker, home theater system, computer, mobile phone, television, communication content player, smart watch, and the like. The electronic device 102 can communicate with one or more of the collection of one or more responsive additional electronic devices 112-116 over the network 111, and/or over a separated wired or wireless link there between to obtain real time context awareness information. For example, the electronic device 102 may be a laptop computer that includes a camera that can obtain related context awareness information, and can also obtain Global Navigation System (GNS) location information from a smart phone of the user that is within the environment. In this manner, the other electronic devices 112-116 may communicate with the electronic device 102 of the user to provide context awareness information.

The electronic device 102 is configured to access the network resources 118, including web-based or network-based data, applications, webpages, and services, via the network 111. The network 111 may represent one or more of a local area network (LAN), a wide area network (WAN), an Intranet or other private network that may not be accessible by the general public, or a global network, such as the IoT or other publicly accessible network. The network 111 provides communication between the electronic device 102 and one or more network resources 118. It will be understood that, in some embodiments, the network resources 118 may represent a single entity or one or more physical or virtual servers that are configured to deliver online resources to the electronic device 102. Examples of the network resources 118 include, but are not limited to, web pages, websites, web-based or network-based data storage services, social networking applications, shopping services, payment services, multimedia content delivery services, financial services and the like. The resources 118 may represent a Web service or a network service for an e-commerce business, financial institution, or any other commercial, noncommercial, personal, nonprofit or other entity.

The electronic device 102 also includes a research application 110. The research application 110 as used herein does not refer to a search engine, and thus as an example does not refer to a search engine such as Google, Bing, Yahoo, industry specific search engines, or the like. Instead, the research application 110 can function in conjunction with a search engine, including, but not limited to each of the listed search engines, to facilitate researching of information, including from such search engines.

The research application 110 includes program instructions to obtain user instructions, and utilize the user instructions to determine a research subject matter topic, and enhance a search. The user instructions may be obtained from keystrokes, natural language processing, microphone, or the like.

The research application 110 includes program instructions to obtain real time context awareness information, analyze the real time context awareness information, and make determinations to facilitate obtaining relevant information related to a search based on the context awareness information in real time. In one example, the program instructions are based on the user instructions. Based on the context awareness information, the research application 110 can identify user characteristic, environment characteristic, etc. to facilitate research.

As an example, the context awareness information may include a student login and profile, a voice identification from a microphone, an input from a student of their age, or grade, or the like. Then based on the identification of the user, and the user characteristics, the research application 110 can access research information in the memory 154 related to a search. As an example, when a class of students is researching major battles of the Revolutionary War, once the user is identified as a 6^{th} grade student, the research application 110 finds additional resources previously uncovered such as searches, search terms, webpages, files, papers, or the like that previously assisted other 6^{th} grade students researching the subject matter topic. In this manner, instead of directing an inquiry through a search engine that may result in websites directed towards adults, contain images that are not appropriate for children, etc. context relevant additional resources and searches related to the assignment are found and searched. Similarly, as the 6^{th} grade user researches new webpages, provides new search terms, etc., the research application 110 can determine which new information is helpful and relevant to the search and user.

In order to determine the research application 110 is providing relevant information for the particular use, the research application 110 can monitor web history for the user. In one example, an artificial intelligence, and/or machine learning algorithm can be utilized to make determinations related to the context awareness information. For example, the research application 110 can include program instructions to monitor how long students stay on a given website. In one example, the program instructions can include a threshold duration, such as two minutes, and if the threshold duration is exceeded, the research application 110 may determine the website is helpful, useful, or relevant for the search. To this end, the research application 110 can include program instructions to associate a user age, (through a user input, voice recognition, or the like). In all, once the search engine determines the threshold duration has been reached, then the research application 110 can associate the search subject matter topic with the user characteristics and the webpage in the memory to be recalled during a later search.

While in some examples a threshold time can be provided, in other examples, an algorithm may be utilized that combines the amount of time spent with other factors such as eye movement, screen movement, webpage interactions such as clicking or actuating links on the page or the like. Still, the assumption can be made that if a user is on a website for a longer period of time, it is possible that the website has been of some use. Likewise, if a user accesses a website, then quickly accesses another website, it is possible the first website was not useful, and thus does not have to be stored.

In another example, the research application 110 can include program instructions to monitor how a student interacts with a given resource. For example, if the context awareness information indicates that a user starts at the top and slowly scrolls to the bottom, it is possible the student is getting benefit from reading or viewing the site.

In yet another example, the research application 110 can include program instructions for monitoring student workgroups for patterns that indicate a resource such as a website is proving to be useful. For example, four students are working together. Student A goes to a website, and then soon after, Students, B, C and D all navigate to that same website. Again, this is yet another way to determine that a website is useful or helpful and is to be stored in the memory to be accessed by other similarly situated users.

In another example, a sentiment analysis of chat messages or vocal communication within the group can be analyzed at the time that a resource is loaded in a student browser. This can help determine if the students in a workgroup are having a positive or negative experience with a website. The research application 110 can also provide an emotion analysis such as by using cameras, or other sensors, that can be used to determine if students in a workgroup are having a positive or negative experience with a given resource. In yet another example, the research application 110 uses natural language processing to analyze the content of the page to determine the validity of the content of the page compared to the current subject matter topic. Likewise, analysis of the reading level of the page could be used to determine if it could be understood by the target audience. To this end, the sentence structure, picture to word ratio, or the like of a resource can be analyzed to determine if the resource is relevant based on the age of the user.

In each instance, determinations are made by the research application 110 to determine whether a resource such as a webpage, search term, etc. is helpful or used by a determined user so that the webpages, search term, etc. can be stored and accessed when a similarly situated user conducts the same or similar search. Alternatively, by analyzing one or more webpages that are obtained from a search engine search, the research application 110 can reprioritize the order of the webpages consistent with the user. For example, if from the context awareness information a determination is made that a third grader is researching for information related to the planets, the research application 110 can determine the number of words on a website, the number of words per sentence, the average length of words, the number of pictures and/or diagrams compared to the number of words, key words such as thesis, college, etc., titles of links to articles, or the like. By making these determinations, the list of webpages obtained by a search may be reprioritized to provide websites most likely relevant for the third graders. To this end, in another example, upon determining that a webpage is helpful or relevant, the research application 110 can analyze the webpage and determine characteristics associated with the webpage, and reprioritize the list of webpages obtained by the search engine accordingly.

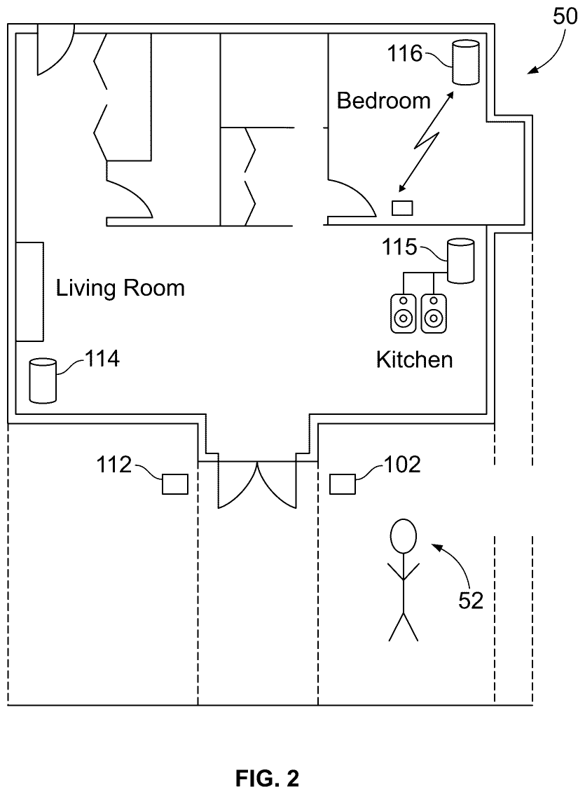

FIG. 2 illustrates a top plan view of an environment in which embodiments herein may be implemented. The environment 50 may represent a home, office, classroom, or other structure. In the example of FIG. 2, the environment 50 represents a home with an outdoor exterior region 52, a living room region, kitchen region and bedroom region. The electronic devices 102, 112-116 are shown at representative locations distributed throughout the environment 50. Embodiments herein consider real time context awareness information indicative of individuals that are within a proximal range of the electronic devices 102, 112-116, as well as the activities currently being undertaken by the individuals proximate to the electronic devices 102, 112-116.

By obtaining real time context awareness information related to the environment and other potential individuals in the environment, the research application 110 can make determinations regarding resources such as research, webpages, etc. that may facilitate a search. For example, by determining that a search is being conducted in a home environment by a teenager, when a search is done on “the American Presidents” a determination may be made that the teenager is researching the musical group, and not actual American Presidents. As a result, previous searches by other teenagers in a home environment related to the band may be obtained, or websites prioritized. In contrast, if the environment is determined to be within a school, library, etc., webpages related to a list of the Presidents of the United States can be obtained and accessed. As a result of analyzing context awareness information for environmental characteristics, the research application can vary webpages or information provided during a search.

In another example, the research application can determine that an adult is sitting at an electronic device, and another individual is sitting by the adult who is identified as a child. When this determination is made, research, search terms, etc. relevant to the child may be provided instead of relevant to the adult. To this end, the assumption is made that the adult is helping the child research a subject matter topic, and thus additional resources including results, information, webpages, etc. are provided that are tailored to the child, even though the adult is providing inputs. To this end, webpages may be analyzed for inappropriate language, content, images, etc. to prevent inappropriate content from being displayed to the child.

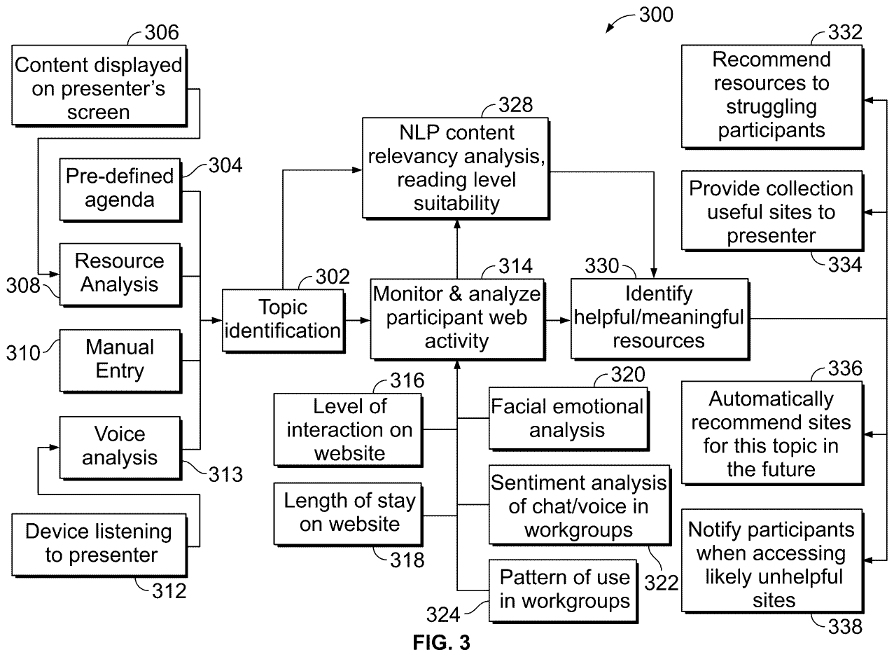

FIG. 3 illustrates a block flow logic diagram of a system 300 for enhancing research. In one example, the research application of the systems of FIGS. 1 and 2 perform the logic steps. In an example, the system 300 can be used by a student who is researching information related to a presentation that is presented by a teacher, and has provided user instructions into a search engine accordingly.

At 302, a subject matter topic related to the research is identified, including based on the user instructions. In order to determine the subject matter topic, topical information is obtained by one or more processors. At 304, the topical information can also include the content provided in a defined agenda. In particular, a teacher can provide a syllabus, agenda, program, assignment, or the like that can be analyzed by a research application to determine the content of the defined agenda.

The topical information can also include, at 306, content displayed on a screen of a presenter. In one example, the presenter can have an electronic device that is connected to the network that includes the research application. The research application can then analyze the content on the display at 308 via resource analysis. In another example, the electronic device of the student can include a camera that captures an image of the display of the electronic device of the presented and at 308 via resource analysis the content on the display is similarly determined.

The topical information can additionally include, at 310, a user instructions such as a manual entry, including an input into a search engine, a settings input, an inquiry input, or the like. In particular, manual entries, keystrokes, settings, etc. can be tracked, analyzed, etc. to determine the subject matter topic being researched. Similarly, at 312 sound based information can be obtained, including from a microphone or other sensor of the electronic device. The sounds can include user instructions or inquires of a teacher, student, other student, etc. where the research application includes program instructions for voice analysis at 313 to determine the content of the spoken words of each. In each instance, topical information is obtained by sensors, inputs, or the like of the electronic device and analyzed to identify the subject matter topic being researched.

After a subject matter topic is identified, at 314 real time context awareness information is determined related to the user characteristics and environment characteristics. The user characteristics can include physical characteristics of the user such as age, or characteristics related to the actions of the user when reviewing resources including webpages, files, websites, information, etc. For example, at 316 one or more sensors of the electronic device determine in real time the level of interaction the user has with the resource. In one example the research application includes program instructions to determine the number of clicks, inputs, searches, etc. performed by the user while on a website. In another example, at 318 the research application includes program instructions to determine the length of time a user stays on a website. In particular, the longer a user utilizes a website, the more relevance the website likely will have to other users that desire to research the same issue.

In addition, the research application at 320 includes program instructions to analyze the facial emotions of the user while a website is being utilized. In one example, the program instructions obtain image information from a sensor, camera, infrared camera, or the like and provide analysis to determine whether a user is frustrated, unhappy, engaged, happy, etc. In another example, the research application at 322 includes program instructions to determine a sentiment of a group of individuals by analyzing sound information. For example, a microphone may obtain sounds, and the research application may include program instructions to determine words, phrases, or the like to determine whether a webpage is showing the research desired. In examples, a member of the group could say a phrase such as “this is perfect”, “this is what we are looking for”, “finally some relevant information”, etc. that can be identified and recognized as supporting that the webpage contains useful, relevant information.

In yet another example, at the research application can include program instructions to determine webpages being observed on other electronic devices. As an example, in a student setting, a teacher may form groups of two or three students to each research the same subject matter topic, such that ten separate groups are provided. If one of the ten groups finds a website where other user characteristics indicate that the website is useful, helpful, relevant, etc., that website can be automatically shared with the other nine groups also conducting the same search. To this end, at 326 program instructions can be provided to identify a pattern of use at another electronic device by another group working on the project. The pattern of use could include multiple electronic devices in the environment having their camera obtaining data where when a webpage is accessed, users are captured gathering around an output device to read. In particular, when this behavior occurs at more than a threshold number of electronic devices, that in one example can be three, an indication that the webpage is relevant to the subject matter topic is provided.

Once the subject matter topic is identified and the user web activity monitored and analyzed, at 328 program instructions are provided to determine the reading level suitability of the for the users. In particular, determinations can be made utilizing real time context awareness information regarding the age, reading level, etc. of the user. In one example the determination of the reading level is done utilizing natural language processing of content on webpages that are determined to be helpful or relevant to the research. In this manner, one or more processors can prioritize webpages, or additional resources based on the reading level of the user. As a result, if the users are kindergarteners looking up information on George Washington, websites made for children that use more pictures, smaller words, shorter sentences, etc. can be prioritized. Whereas if the reading level suitability were to indicate a college student is conducting the research, websites with more content, less pictures, bigger words, more complex sentences, or the like can be prioritized.

At 330, relevant and meaningful resources are determined based on the user web activity, and reading level suitability determinations. In all, based on identifying the subject matter topic being researched, and real time context awareness information such as characteristics of the user and environment, program instructions are provided by identifying additional resources for the user. In one example, a user can be an elderly person attempting to find information on health care insurance. The research application can identify the user as someone who is over the age of fifty, in a home setting, and spending a significant amount of time scrolling through a website of a health care insurance services company. Based on this information, program instructions may exist to access from a storage device an additional resource that is a list of health care service providers including links to benefits and/or cost pages, reviews of customers having different policies, a list of contact information for insurance agents, or the like.

Alternatively, a high school teacher can be providing a presentation with an electronic device to a class of thirty students broken up into groups of three that each have access to an electronic device in the classroom. The subject matter topic can be related to health care insurance costs and the pros and cons of government assistance in supplementing such costs. In this example, again the subject matter topic is identified as health care insurance costs, but this time the context awareness information indicates that groups of high school students are in a classroom environment with a teacher presenting information on the subject matter topic. Here an initial search may result in finding the same insurance services company website as the elderly person, only this time the students immediately exit the webpage. Once a student immediately closes an initial website, at 332, program instructions may provide a recommendation. To this end, at 334, program instructions may also be provided to provide a list of webpages, articles, data centers, etc. to the presenter to provide to the students based on the context awareness information.

The additional resources may be from a storage device based on the same presentation and searching done by a previous class. In addition, at 336, program instructions can be presented to automatically recommend resources such as sites for the subject matter topic in the future. In particular, when a helpful resource is identified that had not been previously found, the resource may be included in the storage device to provide for a future search. Also, at 338, program instructions may exist to identify from previous additional resources that were simply unhelpful, resulted in frustrations, etc. to allow the student to quickly stop reviewing unhelpful resources. In all, as a result of the searching application, additional resources, including information, websites, lists, articles, can be quickly identified, recommended, while irrelevant resources, including information, websites, lists, articles, etc. can be quickly discarded, facilitating a search for information.

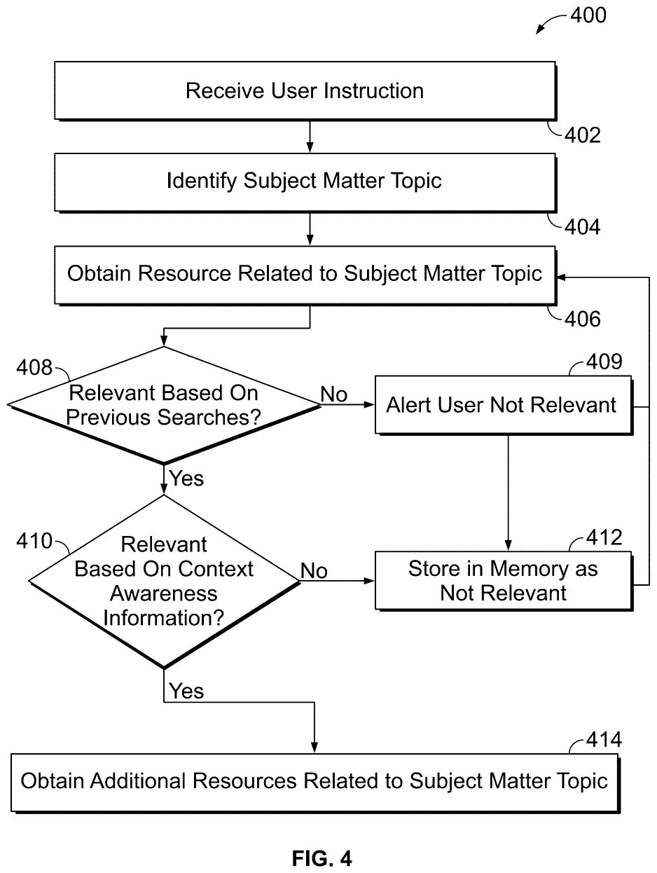

FIG. 4 illustrates a process for enhancing a search on an electronic device. The process may be performed by any of the systems or devices provided in FIG. 1 or 3, or utilized any of the processes or methods of FIG. 3.

At 402, one or more processors receive a user instruction from a user to perform a search on an electronic device. The electronic device can include a laptop computer, desktop computer, smartphone, smart watch, tablet, or the like. The user instructions can be typed into a text box, including of a search engine. The search engine can be a general search engine such as Google, Bing, Yahoo, or the like, or can be a more specialized search engine, such as a Patent Office search engine, a government agency or website search engine, a specialized search engine such as LexisNexis, a commercial search engine such as Amazon, automobile search engine, or the like. The user instructions can also be an audio instruction where the electronic device includes voice to text capabilities. The user instructions can also be in the form of an input, such as clicking or actuating a button, tab, hyperlink, etc. Each represents a user instruction that is attempting to obtain information about a subject matter topic.

At 404, the one or more processors identify a subject matter topic based on the user instruction. In one example, key words or terms of the can be utilized to identify the subject matter topic. In another example, the one or more processors communicate with a research application that receives inputs from the user, a third party, the electronic device, etc. that is used in association with the user instruction to determine the subject matter topic. As an example, a syllabus, agenda, presentation, etc. can be input by a user, presenter, teacher, other third party, into the research application to help determine the subject matter topic. Alternatively, context awareness information can be obtained by the one or more processors in real time and used in association with the user instruction to identify the subject matter topic. For example, an electronic device may use a microphone to obtain instructions of a third party such as a presenter, teacher, lecturer, or the like. Alternatively, a camera of the electronic device may obtain image data of a presentation, lesson, etc. being provided by a third party. In yet another example, an electronic device may capture image data from information displayed on an output device of the electronic device. In each instance, such information, combination of such information, etc. in addition to the user instructions can be analyzed by an algorithm, artificial intelligence algorithm, machine learning algorithm, using a lookup table, decision tree, additional logic, or the like to identify the subject matter topic based on the user instruction.

At 406, the one or more processors obtain a resource related to the subject matter topic. In one example, the resource is a webpage or website provided by a search engine. Alternatively, the resource is a file, webpage, website, list, presentation, paper, etc. stored in a memory of the electronic device, or a memory in communication with the electronic device via a network that is obtained in response to identification of the subject matter topic. In particular, the research application includes numerous resources related to individual searches, presentations, assignments, etc. such that when a particular search, or instruction is identified, the resources are provided. In one example, context awareness information can be utilized in determining what if any stored resources are provided to a user based on the user instruction. For example, the context awareness information may include a student login that identifies a user as an 8^{th} grade student, and as a result, only resources related to 8^{th} grade students are provided from the memory, while resources related to 2^{nd} grade students are not provided. In yet another example, the resource may be provided by a third party, shared by a third party, or the like.

At 408, the one or more processors determine if the resource obtained is relevant to the subject matter topic and user based on previous searches. In one example, a list of resources is within a lookup table associated with subject matter topic inquiry or instruction. Then, when a determination is made that the same subject matter topic search is being made by the similarly situated (e.g. 7^{th} grade students compared to 7^{th} grade students) users, when resources on the list are obtained, at 409, the one or more processors can automatically alert the user that the resource obtained is not relevant. The one or more processors can provide the communication in a pop up text box, text message, electronic mail, color indicator, or the like. Still, the one or more processors provide an immediate indication in real time that the resource is not relevant. To this end, the one or more processors are able to filter through thousands of resources in real time to make such a determination the resource is not relevant to provide the communication. Thus, the user saves time by immediately moving on to a different resource.

If the resource has previously not be identified as not relevant, then at 410, the one or more processors identify and analyze real time context awareness information related to the user interaction with a resource obtained by the electronic device in response to the user instruction to determine if the resource is relevant. Whether the resource is provided as a search engine result, communication from a third party, retrieved from a memory by the research application, or the like, the research application includes program instructions to monitor the user and the environment of the user for context awareness information to determine the relevance of each individual resource. As an example, context awareness information can include the scroll rate through a resource, time spent viewing a resource, audio comments received by a microphone expressing positive or negative reactions to a resource, whether the resource is saved, communicated, deleted, etc. or the like. Based on the context awareness information an algorithm, machine learning algorithm, artificial intelligence algorithm, lookup table, decision tree, etc. determines whether the resource is relevant to the user instruction, or search.

As used herein, the term “relevant” has a definite meaning and is determined by an algorithm, formula, etc. As an example, a function may be provided that if a resource is viewed by the user for more than two minutes before the resource is closed, the resource is considered relevant. Alternatively, if a scroll rate of less than ten mm per minute, but greater than two mm per minute, the resource is considered relevant. In yet another example, if a key word such as “yes”, “finally”, or phrase like “exactly what we need”, etc. is stated, the resource is considered relevant. Whereas if such conditions are not met, the resource is considered not relevant. To this end, a complex algorithm, such as an artificial intelligence algorithm, can take numerous different context awareness information in real time to determine if a resource is relevant or not relevant based on the calculation, determination, etc.

Alternatively, if the resource was not previously determined as not relevant and is determined to not be relevant based on the action of the user, and/or others in the environment, then at 412, the one or more processors store the resource in a memory and indicate the resource is not relevant for the search. In this manner, if another user in the future that is similarly situated undertakes a similar search, the research application can immediately indicate in real time that the resource is not relevant to the search.

If at 410, the resource is determined to be relevant, at 414, the one or more processors obtain additional resources related to the search based on the real time context awareness information related to the user interaction with the resource. Once a resource is determined to be relevant, the research application can obtain other similar resources from a memory. In another example, the research application can include program instructions to obtain the additional resources of a list of resources (e.g. links to webpages) from a search engine, and then reprioritize the list of resources so that the most relevant resources are listed first. For example, the program instructions may include analyzing the resource determined to be relevant for resource characteristics such as the number of figures or diagrams to words, length of words, words per paragraph, specific words, or the like. In particular, by analyzing the resource characteristics, the determinations may be made about the age, education level, etc. of the user. For example, a 2nd grader reviewing a resource about Abraham Lincoln will find resources with more pictures, smaller words, less words, etc. relevant, whereas a college student reviewing the resource will not find such resource characteristics as relevant. Consequently, by analyzing the resource characteristics, the research application can find other resources with similar resource characteristics and/or reprioritize such resources to ensure the additional resources obtained are more relevant than if the research application was not utilized. In one example, a file is created with the additional resources and communicated to the user, either as a pop-up file, attached to an electronic mail, or the like. In this manner, an improved and enhanced searching of information can be provided.

### CLOSING STATEMENTS

Before concluding, it is to be understood that although e.g., a software application for undertaking embodiments herein may be vended with a device such as the system 100, embodiments herein apply in instances where such an application is e.g., downloaded from a server to a device over a network such as the Internet. Furthermore, embodiments herein apply in instances where e.g., such an application is included on a computer readable storage medium that is being vended and/or provided, where the computer readable storage medium is not a carrier wave or a signal per se.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An electronic device for research, comprising:
an input device to receive a user instruction of a user to perform a search;
a sensor configured to obtain real time context awareness information, wherein the context awareness information is information indicative of a condition present in a physical region of a classroom in which the electronic device is located;
a processor;
a memory storing program instructions accessible by the processor, wherein, responsive to execution of the program instructions, the processor performs the following:
performing the search related to a subject matter topic to identify a resource related to the subject matter topic based on the user instruction and the subject matter topic;
obtaining the resource related to the subject matter topic;
obtaining the real time context awareness information related to the user interaction with the resource related to the subject matter topic obtained by the electronic device in response to the user instruction; and
automatically obtaining additional resources related to the subject matter topic and the search performed based on the real time context awareness information related to the user interaction with the resource identified when performing the search without input from the user.

2. The electronic device of claim 1, wherein the processor further performs the following:
determining the resource is relevant to the search based on the user interaction with the resource;
analyzing the resource related to the subject matter topic obtained by the electronic device in response to determining the resource is relevant to the search; and
identifying the additional resources based on analyzing the resource.

3. The electronic device of claim 2, wherein to analyze the resource includes utilizing a natural language processing of the resource.

4. The electronic device of claim 1, wherein the processor further performs the following: analyzing the real time context awareness information to determine the additional resources.

5. The electronic device of claim 4, wherein the processor utilizes an artificial intelligence algorithm or machine learning algorithm to analyze the real time context awareness information in real time to determine the additional resources.

6. The electronic device of claim 1, further comprising a camera for obtaining real time context awareness information.

7. The electronic device of claim 1, wherein the additional resources include a file related to the subject matter topic.
